(19) United States
(12) Patent Application Publication
(10) Pub. No.: US 2024/0337031 A1
(43) Pub. Date: Oct. 10, 2024

(54) Single-Layer Bipolar Plate for an Electrolyser

(71) Applicant: Reinz-Dichtungs-GmbH, Neu-Ulm (DE)

(72) Inventors: Jonas LEISCHER, Neu-Ulm (DE); Christoph SPECHT, Neu-Ulm (DE); Steffen ERTHLE, Darmstadt (DE); Hans WALDVOGEL, Krumbach (DE); Wilhelm KUHN, Tomerdingen (DE); Oliver CLAUS, Laichingen (DE); Franz SCHWEIGGART, Pfaffenhofen (DE)

(21) Appl. No.: 18/535,914

(22) Filed: Dec. 11, 2023

(30) Foreign Application Priority Data
Dec. 12, 2022 (DE) 20 2022 106 920.4

(51) Int. Cl. C25B 13/02

(52) U.S. Cl. CPC C25B 13/02

(57) ABSTRACT

A single-layer bipolar plate for an electrolyser. The single-layer bipolar plate comprises a flow field which is shaped substantially as an equilateral n-sided polygon. The flow field being predefined by an embossed channel structure which defines a plurality of channels for a reaction medium. Here, n may be an even natural number. The single-layer bipolar plate comprises at least four media apertures, wherein, on each of four different sides of the flow field, in each case at least one media aperture is arranged between the flow field and a respective outer edge of the bipolar plate.

### CROSS-REFERENCE TO RELATED APPLICATION

The present application claims priority to German Utility Model Application No. 20 2022 106 920.4, entitled “SINGLE-LAYER BIPOLAR PLATE FOR AN ELECTROLYSER”, and filed on Dec. 12, 2022. The entire contents of the above-listed application is hereby incorporated by reference for all purposes.

### TECHNICAL FIELD

The disclosure relates to a single-layer bipolar plate for an electrolyser. The single-layer bipolar plate comprises a flow field which is shaped substantially as an equilateral n-sided polygon, said flow field being predefined by an embossed channel structure which defines a plurality of channels for a reaction medium. Here, n may be an even natural number. The single-layer bipolar plate comprises at least four media apertures, wherein, on each of four different sides of the flow field, in each case at least one media aperture is arranged between the flow field and a respective outer edge of the bipolar plate.

### BACKGROUND AND SUMMARY

Electrochemical systems such as an electrolyser or a fuel cell or a redox flow battery usually comprise a plurality of bipolar plates which are layered one above the other and which, by way of an outer housing, are held together jointly with sealing units, frame units and membrane units in order thus to enable the largest possible chemically active membrane surface area. When used as intended, one side of the bipolar plate, an anode side, faces towards an anode in the electrochemical system, and another side of the bipolar plate, a cathode side, faces towards a cathode of the electrochemical system.

For such electrochemical systems, U.S. Pat. No. 8,349,151 B2 describes for example a universal cell frame for use as an anode frame and as a cathode frame in a water electrolyser. The universal cell frame may comprise a unitary annular member having a central opening. Four trios of transverse openings are provided in the annular member, each trio being spaced apart by about 90 degrees. A plurality of internal radial passageways fluidically interconnect the central opening and each of the transverse openings of two diametrically opposed trios of openings, while the two other trios of openings do not have such radial passageways. Sealing ribs are provided on the top and bottom surfaces of the annular member. In such a water electrolyser, at least two cell frames of this type are then provided, one being used as the anode frame and the other being used as the cathode frame, the cathode frame and the anode frame being rotated through 90 degrees relative to each other.

DE 20 2015 106 107 U1 discloses a separator plate for an electrochemical system, comprising two individual plates and a cavity arranged between the individual plates for the passage of a cooling medium, wherein at least one of the individual plates has an active region with structures for guiding a reaction medium on an outer side of the separator plate, as well as a bead which is designed to seal off the active region or to seal off an opening in the separator plate. The opening is designed for feeding a cooling medium into the cavity or for discharging a cooling medium from the cavity, and the bead has at least one lowered area in which the height of the bead top is smaller than the average height of the bead top determined along the course of the bead. A minimum height of the bead top in the lowered area is smaller than or equal to a maximum height of the structures of the active region.

Documents DE 102 50 991 B4 and DE 10 2007 048 184 B3 each disclose a two-layer bipolar plate for a fuel cell, wherein the two-layer bipolar plate comprises two individual plates which are connected to each other. Located between the individual plates is a cavity for the passage of a coolant.

Proceeding from the known prior art, the problem addressed is therefore that of providing an improved separator plate or bipolar plate for an electrochemical system, which, when used in an electrochemical system, leads to a system that is mechanically more stable, optimized in terms of flow and simplified in terms of the structure.

This problem is solved by the subject matter of the independent claim. Further embodiments will emerge from the dependent claims, the description and the figures.

One aspect relates to a single-layer bipolar plate for an electrochemical system such as an electrolyser and/or a fuel cell and/or a redox flow battery. The single-layer bipolar plate comprises a flow field which is shaped substantially as an equilateral n-sided polygon, said flow field being predefined by an (embossed, for example) channel structure. The channel structure accordingly lies within the equilateral n-sided polygon; for instance, an edge of the channel structure, which for example may be predefined by an envelope, may correspond to an edge of the flow field and thus to the shape of the flow field. A “substantially equilateral n-sided polygon” can be understood to mean an equilateral n-sided polygon or a shape that deviates only slightly from an equilateral n-sided polygon, so that the shape is functionally equivalent to an equilateral n-sided polygon in the context of the technical teaching explained here. One example of a substantially equilateral n-sided polygon is an equilateral n-sided polygon with rounded corners.

Here, n is a—for instance even—natural number; alternatively, n may be infinite, e.g. the flow field may be of circular shape, e.g. may be a round flow field, as described further below. For example, n may be equal to 4 or 8, e.g., the flow field may be substantially a four-sided or eight-sided flow field with sides of equal length. The square or octagonal shape may be suitable here since, with low design complexity, a uniform flow therethrough may be achieved, e.g. with little turbulence, an available installation space is utilized efficiently and in a material-saving manner, and a rotation of adjacent bipolar plates relative to each other, as will be described below, may be implemented easily, for instance in a way that is easy to install.

The channel structure defines a plurality of channels for a medium such as an electrolyte or water, for example, with respective channel walls of the channel being formed on the bipolar plate. Further boundaries may be formed, for example, by a membrane unit or a sintered metal unit comprising porous transport layer elements. Most or all of the channels predefined by the channel structure may be rectilinear channels. On the one hand, this may lead to flow conditions in the channels formed by the bipolar plate, and on the other hand a force transmission and force fit in a stacking direction may be distributed evenly when the bipolar plates are stacked in an electrochemical system. The symmetrical arrangement of the media apertures described in the next section enables the use of rectilinear channels with unprecedented efficiency and effectiveness.

The bipolar plate has at least four media apertures or media through-openings in total, wherein, on each of four different sides of the flow field, in each case at least one media aperture is arranged between the flow field and a respective outer edge of the bipolar plate. In each case at least one media aperture is arranged on a first side and on a second side adjacent to the first side. For example, two sides which are separated by at most one other side are considered as adjacent here. In the case of an equilateral quadrilateral, e.g. n=4, the second side (of four sides) may be arranged next-adjacent to the first side (of four sides), e.g. the first and the second side adjoin each other via a corner. In each case at least two media apertures are arranged on a third side and on a fourth side adjacent to the third side. In the case where n=4, the fourth side (of four sides) is next-adjacent to the third side (of four sides). For example, the first and the third side are opposite sides, for instance diametrically opposite sides, and the second and the fourth side are opposite sides, for instance diametrically opposite sides. In the case where n=8, the first, the second, the third and the fourth side (of eight sides) are each separated by a further side of four sides that can be referred to as intermediate sides.

The media apertures are arranged symmetrically with respect to an axis of symmetry that extends from a first anchor point at the edge of the flow field, which is located between the first and the second side and is equidistant from the first and the second side, to a second anchor point at the edge of the flow field, which is located between the third and the fourth side and is equidistant from the third and the fourth side. The axis of symmetry thus extends diagonally through the flow field, for instance through a centre point of the flow field. For the case where n=4, the first anchor point may be the corner of the flow field between the first and the second side, and the second anchor point may be the corner of the flow field between the third and the fourth side, or may be situated at said respective corners. In the case where n=8, the first anchor point may be situated on a median of a first intermediate side situated between the first and the second side, and the second anchor point may be situated on a median of a third intermediate side situated between the third and the fourth side.

In the case of a round flow field, the first, the second, the third and the fourth side may be specified as sides corresponding to the respective angular ranges of, for example, 90 degrees or 45 degrees. The anchor points may then be situated on the edge (and thus on the radius) of the flow field between the sides or angular ranges, for example in the middle between respective central directions of said angular ranges defining the sides.

The symmetrical arrangement with the aforementioned distribution makes it possible to combine an optimized flow cross-section with a direct force fit between stacked bipolar plates with a simplified structure in which all the bipolar plates are structurally identical. With the described geometry, therefore, a mechanically resilient electrochemical system with an optimized flow cross-section can be easily built up by way of a different orientation, namely by way of next-adjacent bipolar plates which in each case are rotated through 180 degrees about the axis of symmetry or are rotated through 360/n degrees about an axis of rotation that extends perpendicular to the main extension plane of the bipolar plate.

In another embodiment, it is provided that an equal number of media apertures, for example at least or exactly three media apertures, are arranged on each of the four different sides. This has the advantage of increasing the degree of symmetry, and as a result the bipolar plate not only can be used in one of the two different rotations, but is suitable for both of the different rotations depending on the connection scenario. There may be a choice of three media apertures here, since the different inlet/outlet quantities of the media and of the electrolyte may thus be balanced well.

In another embodiment, it is provided that the media apertures are arranged point-symmetrically in relation to each other, for instance point-symmetrically with respect to a centre point of the flow field. This increase in symmetry also enhances the flexibility mentioned in the last paragraph and furthermore improves the flow properties of an electrochemical system, formed by the bipolar plates described here, in a flow direction extending perpendicular to the main extension plane of the bipolar plate, into inlets and outlets through which the respective media are routed towards or away from the channel structures of the flow fields.

In another embodiment, it is provided that sealing contours assigned to the media apertures, which seal off the media apertures and optionally compartments adjoining the media apertures with respect to a surrounding environment, in each case have the same shape, for example a substantially rectangular shape. Alternatively, or in addition, envelopes assigned to the media apertures may in each case have the same shape, for example a substantially rectangular shape. A force fit between bipolar plates arranged one above the other in the electrochemical system may thus be efficiently achieved. For instance, the media apertures also in each case have the same shape or aperture surface area, which improves the flow properties in the flow direction perpendicular to the main extension plane of the bipolar plate.

Optionally, the bipolar plate is substantially flat in the flow direction between the flow field and at least one of the media apertures, a plurality of the media apertures or each of the media apertures. For the sake of simplicity, reference will be made below to one media aperture, but this may mean at least one of the media apertures, a plurality of the media apertures or each of the media apertures. By way of example, the bipolar plate is substantially flat in a first region adjoining the media aperture and extending around the media aperture and/or in a second region adjoining the flow field and extending around the flow field. For instance, in said regions, the bipolar plate has no sealing elements such as sealing beads, elastomer seals and/or depressions for receiving elastomer seals. The sealing-off of the media apertures and/or the flow field and the guiding of fluid between the respective media aperture and the flow field may be performed by at least one of the separate sealing units described below, while the bipolar plate is designed for electrical contact and for separating and distributing the media. A configuration of the media apertures of the bipolar plate may be determined by a separate sealing unit, see explanations below. Since the bipolar plate itself does not have an elastomer seal around the media apertures and the flow field, in the event of servicing the bipolar plate can be removed relatively easily, serviced, optionally cleaned, optionally recoated, and reused. In addition, as already explained above, structurally identical bipolar plates can be used in the stack, which may even have the same orientation as each other, e.g. may not be rotated.

Another aspect relates to an electrolyser, comprising a plurality of bipolar plates according to one of the described embodiments, which are arranged one above the other in a stacking direction. The stacking direction extends perpendicular to the main extension plane of the bipolar plates and thus perpendicular to a flow direction in the channels predefined by the channel structure. The advantages already outlined for the bipolar plates are correspondingly achieved for the electrochemical system.

In another embodiment, it is provided that bipolar plates which are next-adjacent in the stacking direction are arranged in a manner rotated through 180 degrees about the axis of symmetry and/or are arranged in a manner rotated through plus or minus 360/n degrees, e.g. in a clockwise or counterclockwise direction, about an axis of rotation that extends perpendicular to the main extension plane of the bipolar plates. In the case where n>4, the next-adjacent bipolar plates may also be arranged in a manner rotated through a multiple of 360/n degrees about the axis of rotation. For example, in the case of bipolar plates with a quadrilateral flow field, next-adjacent bipolar plates may be arranged in a manner rotated through plus or minus 90°; in the case of bipolar plates with an 8-sided flow field, the next-adjacent bipolar plates may be arranged in a manner rotated through plus or minus 45°, but also in a manner rotated through plus or minus 90° or in a manner rotated through plus or minus 135°. The possibilities may be flexible in the case of a round flow field, in which case any rotation only has to satisfy the condition that the media apertures must again be suitably arranged one above the other.

Accordingly, most or all of the bipolar plates of the electrochemical system are structurally identical or at least have identical features with regard to the features described here.

In another embodiment, it is provided that arranged between two next-adjacent bipolar plates is a cathode compartment sealing unit which, on a cathode side of the respective bipolar plate, seals off one or more media apertures, for example all media apertures, on two adjacent sides, such as two next-adjacent sides, with respect to a cathode compartment, through which the channels extend on the cathode side of the respective bipolar plate, and seals off in each case at least one media aperture on two remaining adjacent sides, for instance two remaining next-adjacent sides, with respect to the cathode compartment, and fluidically couples in each case at least once media aperture on the two remaining adjacent sides, for instance the two remaining next-adjacent sides, to the cathode compartment, e.g. is designed to allow fluidic coupling when used as intended. The described cathode compartment sealing unit ensures safe discharging of the product medium and at the same time enables the use of structurally identical bipolar plates since the sealing unit defines the configuration of the media apertures.

In another embodiment, it is provided that arranged between two next-adjacent bipolar plates is an anode compartment sealing unit which, on an anode side of the respective bipolar plate, seals off in each case at least one media aperture, for example all media apertures, on two different sides, for instance opposite sides, with respect to an anode compartment, through which the channels extend on the anode side of the respective bipolar plate, fluidically couples one or more media apertures, for example all media apertures, on a further side, which is different than the two different sides, to the anode compartment, and fluidically couples in each case at least one media aperture on a remaining side, for example a side located opposite the further side, to the anode compartment; and seals off in each case at least one media aperture on the remaining side, for example the side located opposite the further side, with respect to the anode compartment. Opposite sides may be diametrically opposite sides. The described anode compartment scaling unit ensures safe feeding and discharging of the media, and at the same time enables the use of structurally identical bipolar plates since, instead of the bipolar plate, the sealing unit defines the configuration of the media apertures. This anode compartment sealing unit, especially in combination with the above-described cathode compartment sealing unit, thus may contribute to beneficial flow conditions in the electrochemical system, which can be achieved using bipolar plates that are structurally identical or that have identical features.

Hereinbelow, reference is made to a sealing unit, which may mean the anode compartment sealing unit and/or the cathode compartment scaling unit. The scaling unit may comprise a frame-like layer having a cutout, wherein the layer surrounds an electrochemically active region, for instance the flow field of the bipolar plate, in the manner of a frame, with the cutout extending across this region. The material of the layer may be made of plastic or a metal, for example. If a metal layer is provided, the layer may be coated with an electrically insulating layer, such as an insulating varnish. The layer may also have at least four through-openings for the passage of media, wherein the number of through-openings of the sealing unit corresponds to the number of media apertures of the bipolar plate. The four through-openings of the layer are then brought into congruence with the media apertures of the bipolar plate. By way of example, the scaling unit comprises a first sealing element for sealing off the through-openings. The scaling unit may also comprise a second sealing element for sealing off the electrochemically active region and the cutout. Said sealing elements may be designed as elastomeric sealing elements, for example elastomer beads, or sealing beads. Some of the sealing elements are arranged in a manner extending circumferentially around the through-openings and thus completely seal off the through-openings, so that the medium in question cannot escape laterally from the through-opening or the media aperture of the bipolar plate located therebelow or thereabove. Some of the sealing elements in turn enable a lateral flow of medium from the through-opening towards the electrochemically active region or the flow field of the bipolar plate. To this end, a fluid-guiding structure may be provided in conjunction with the sealing element in question, said fluid-guiding structure extending between the through-opening and the electrochemically active region and fluidically connecting the two together.

The sealing unit and the bipolar plate are pressed together in the electrolyser in such a way that the sealing elements of the sealing unit seal off the media apertures of the bipolar plate and the flow field of the bipolar plate.

The above-described sealing units thus perform sealing functions and ensure that the media apertures of the bipolar plate and the flow field of the bipolar plate are sealed off. The scaling units may additionally perform the fluid-guiding function between the through-opening and the flow field.

The features and combinations of features mentioned above in the description, including in the introductory part, as well as the features and combinations of features mentioned below in the description of the figures and/or shown in the figures alone, can be used not only in the combination specified in each case, but also in other combinations, without departing from the scope of the present disclosure. Embodiments of the present disclosure which are not explicitly shown and explained in the figures, but which are apparent and are able to be produced by separated combinations of features from the explanations given, are thus also to be regarded as encompassed and disclosed. Embodiments and combinations of features which therefore do not contain all the features of an originally formulated independent claim are also to be regarded as disclosed. Embodiments and combinations of features which go beyond or differ from the combinations of features set out in the dependencies of the claims are also to be regarded as disclosed, for instance through what has been stated above.

The subject matter according to the present disclosure will be explained in greater detail with reference to the schematic drawings shown in the following figures, without there being any intention to limit this to the specific embodiments shown here.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1A shows a view of an exemplary bipolar plate with a substantially square flow field.

FIG. 1B shows an exemplary configuration of the media apertures of the bipolar plate from FIG. 1A in an electrochemical system comprising a plurality of bipolar plates arranged one above the other in a stacking direction.

FIG. 1C shows an anode side of a first bipolar plate featuring a seal course, as shown in FIG. 1A, in such an electrochemical system.

FIG. 1D shows a cathode side of the bipolar plate from FIG. 1C featuring a seal course.

FIG. 1E shows an anode side of a second bipolar plate featuring a seal course according to FIG. 1A, which is arranged in the electrochemical system in a manner rotated through 90 degrees;

FIG. 1F shows a cathode side of the bipolar plate from FIG. 1E featuring a seal course.

FIG. 2A shows an exemplary distribution of force-fit areas between adjacent bipolar plates in a plate plane, as known from the prior art.

FIG. 2B shows a spatial distribution of force-fit areas between adjacent bipolar plates, as can be achieved with the bipolar plate from FIGS. 1A and 1n an electrochemical system comprising bipolar plates arranged one above the other in a manner rotated through 90 degrees.

FIG. 3 shows an exemplary electrochemical system comprising bipolar plates stacked one above the other in a stacking direction and further components interposed therebetween.

FIG. 4A shows a view of another exemplary bipolar plate with a substantially octagonal flow field.

FIG. 4B shows a view of two bipolar plates from FIG. 4A arranged one above the other in a manner rotated through 45° about an axis of rotation.

FIG. 5 shows an exploded view of an assembly consisting of a bipolar plate, a cathode sealing unit and a gas diffusion layer.

FIG. 6 shows an exploded view of an assembly consisting of a bipolar plate, a transport layer, an anode compartment sealing unit and a membrane electrode unit.

FIG. 7 shows an exploded view of two stacked electrochemical cells of an electrolyser.

### DETAILED DESCRIPTION

In the different figures, elements which are identical or which have the same function are provided with the same reference signs.

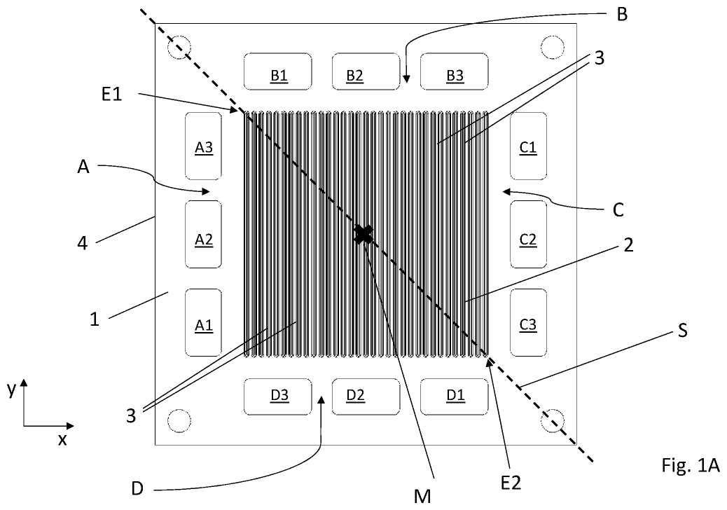

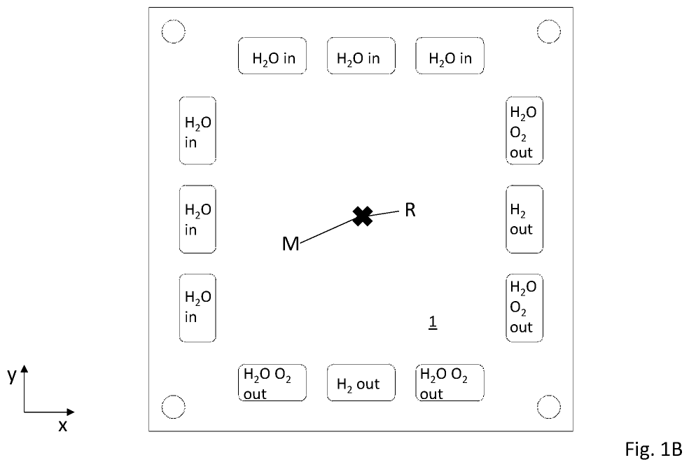

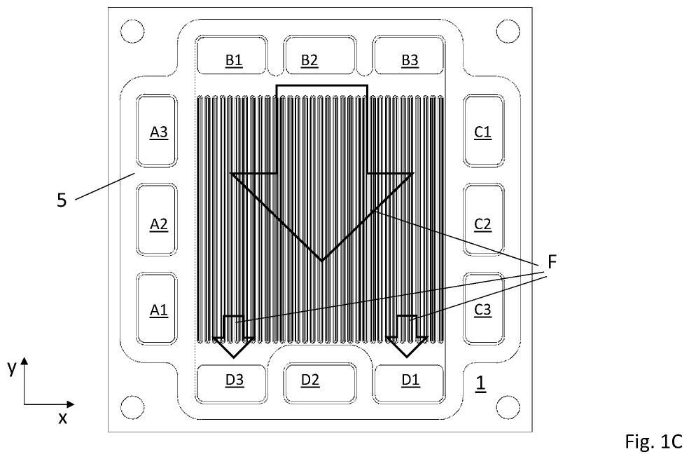

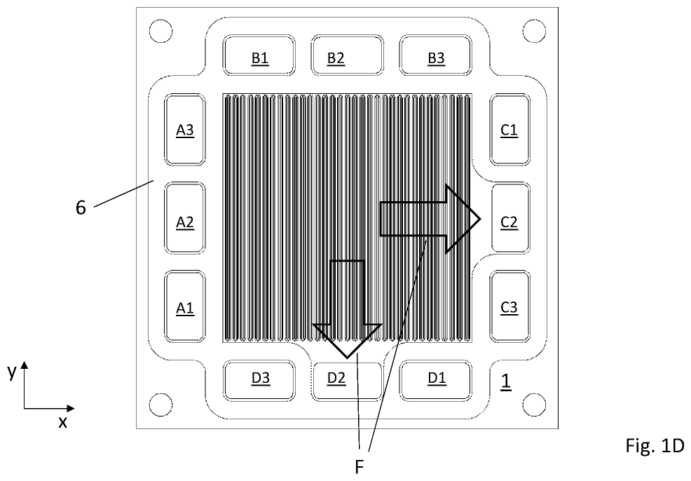

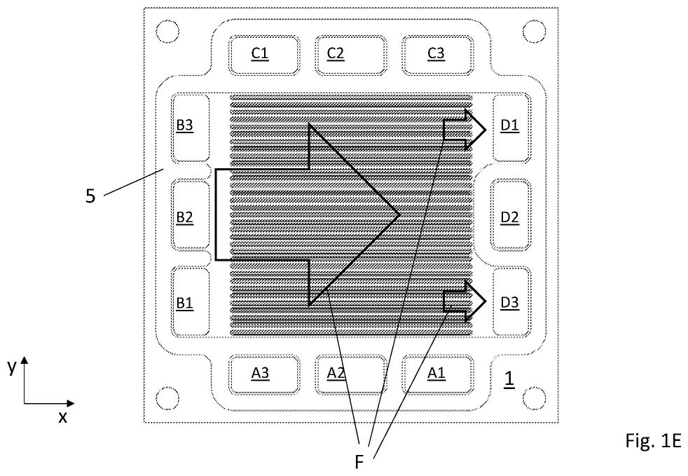

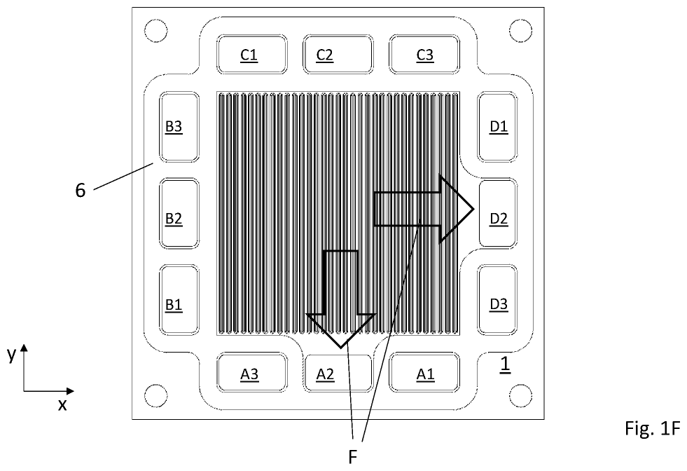

FIG. 1A shows an exemplary embodiment of a single-layer bipolar plate 1 in a plan view of the main extension plane, e.g. the xy plane of the bipolar plate 1. The bipolar plate 1 comprises a flow field 2 which is shaped substantially as an equilateral n-sided polygon, in this case as a square (equilateral quadrilateral), said flow field being defined by a channel structure (embossed in the present case) comprising a plurality of channels 3 for a medium such as an electrolyte or water. In principle, n may be, for example, an even natural number. On each of four different sides A, B, C, D of the flow field 2, the bipolar plate comprises in each case at least one media aperture A1, A2, A3, B1, B2, B3, C1, C2, C3, D1, D2, D3 between the flow field 2 and a respective outer edge 4 of the bipolar plate 1. Here, in each case at least one media aperture A1, A2, A3, B1, B2, B3 is arranged on a first side A and on a second side B adjacent to the first side A, and in each case at least two media apertures C1, C2, C3, D1, D2, D3 are arranged on a third side C and on a fourth side D adjacent to the third side C. In the present case, however, a plurality of, here exactly three, media apertures A1-D3 are arranged on each of the four sides.

The media apertures A1-D3 are arranged symmetrically with respect to an axis of symmetry S that extends from a first anchor point E1 at the edge of the flow field 2, which is located between the first side A and the second side B and is equidistant from the first and the second side A, B, to a second anchor point E2 at the edge of the flow field 2, which is located between the third side C and the fourth side D and is equidistant from the third and the fourth side C, D. In the example shown, the axis of symmetry S also extends through a centre point M of the flow field 2. In the present case, the media apertures A1-D3 are also arranged point-symmetrically in relation to each other with respect to the centre point M of the flow field 2. In the example shown, the media apertures and thus also the associated sealing contours in each case have the same shape, here a substantially rectangular shape, e.g. in this example a rectangular shape with rounded corners. In the example shown, all the channels 3 are rectilinear channels 3, which furthermore in the present case have the same length and extend parallel to the first side A and to the third side C located opposite the first side.

FIG. 1B shows an exemplary configuration of the media apertures A1-D3 in an electrochemical system constructed using bipolar plates 1 as shown in FIG. 1A. Referring to the orientation of the bipolar plate 1 in FIG. 1A, the media apertures A1 to A3 on the first side A and the media apertures B1 to B3 on the second side B are used as water inlets “H₂O In” in the example shown. On the third side C, one media aperture C2 is used as a hydrogen outlet “H₂ Out” and at least one further media aperture, here two media apertures C1, C3, is used as an oxygen and water outlet “H₂O O₂ Out”. The same applies to the media apertures D2 and D1 and D3 on the fourth side D.

With the exemplary geometry from FIG. 1A, the bipolar plate design shown therein can be used to construct the electrochemical system using a single type of bipolar plate 1. In this case, a bipolar plate 1 is arranged in a manner rotated through 180 degrees about the axis of symmetry S relative to the next-adjacent bipolar plate 1 in the stacking direction, the z-direction, or in a manner rotated through 90 degrees about an axis of rotation R which extends perpendicular to the main extension plane of the bipolar plates, the xy plane, and which here also extends through the centre point M of the flow field 2. In the example shown, both rotations lead to the construction of an electrochemical system with a direct force fit across all flow fields of the stacked bipolar plates with an optimized flow behaviour and a simplified structure, as explained with reference to FIGS. 1c to 1f.

FIG. 1C shows the anode side of a bipolar plate, e.g. the side of the bipolar plate 1 that faces towards one of the anodes when stacked, in a first orientation of the bipolar plate 1 in which the flow direction F (here of H₂O) in the present case extends in the negative y-direction, said anode side featuring an anode compartment sealing unit 5. The anode compartment sealing unit 5 is adapted to the flow direction F, which in the present case extends in the negative y-direction, in that it fluidically couples one or more, here all, of the media apertures on the second side B to an anode compartment, through which the channels 3 extend on the anode side of the bipolar plate 1 shown. Furthermore, on the fourth side D, which is located opposite (here diametrically opposite) the second side B, in each case at least one media aperture D1, D3 is fluidically coupled to the anode compartment and in each case at least one media aperture D2 is sealed off with respect to the anode compartment. All the media apertures A1-A3 on the first side A and C1-C3 on the third side C, which is located opposite (here diametrically opposite) the first side A, are sealed off with respect to the anode compartment.

FIG. 1D shows the cathode side of the bipolar plate 1 from FIG. 1C, featuring a cathode compartment sealing unit 6. The cathode compartment sealing unit 6 is adapted to flow directions F in the negative y-direction and positive x-direction in that all the media apertures A1 to A3 on the first side A and B1 to B3 on the second side B are sealed off with respect to a cathode compartment, through which the channels 3 extend on the cathode side of the bipolar plate 1. Furthermore, the cathode compartment sealing unit here seals off in each case at least one media aperture C1, C3, D1, D3 on the third and the fourth side C, D with respect to the cathode compartment, and fluidically couples in each case at least one (here a middle) media aperture C2, D2 on the third and here also the fourth side C, D to the cathode compartment. Therefore, the media aperture D2 on the fourth side D that is coupled to the cathode compartment by the cathode compartment sealing unit 6 on the cathode side is the exact one that is sealed off with respect to the anode compartment by the anode compartment sealing unit 5 of the anode compartment. Conversely, the media apertures D1, D3 that are sealed off with respect to the cathode compartment on the cathode side are the exact ones that are coupled to the anode compartment by the anode compartment sealing unit 5 on the anode side (cf. FIG. 1C).

FIGS. 1e and 1f show a bipolar plate 1′ as arranged as the next-adjacent bipolar plate 1′ to the bipolar plate 1 from FIGS. 1c and 1d and configured with the corresponding scaling units 5, 6. FIG. 1E shows the anode side with the anode compartment sealing unit 5, and FIG. 1F shows the cathode side with the cathode compartment sealing unit 6.

In FIG. 1E, the (H₂O) flow direction F extends transversely to the flow direction F in the anode compartment of the next-adjacent bipolar plate 1, as shown in FIG. 1C, namely in the present case in the positive x-direction. One or more, in the present case all, of the media apertures B1-B3 on the second side B are accordingly again fluidically coupled to the anode compartment by the anode compartment sealing unit 5. As in FIG. 1C, at least one media aperture D1, D3 on the opposite side D is accordingly also coupled to the anode compartment, and a further media aperture D2 is fluidically sealed off with respect to the anode compartment. Here, all the media apertures A1-A3 and C1-C3 on the first and the third side A, C are sealed off with respect to the anode compartment by the anode compartment sealing unit 5.

Analogously, as shown in FIG. 1F, on the cathode side of the bipolar plate 1 which is rotated through 90° or 180° compared to the bipolar plate 1 of FIGS. 1c, 1d, at least one media aperture A2, D2 on the first side A and on the fourth side D is fluidically coupled to the cathode compartment, and at least one media aperture A1, A3 on the first side A and D1, D3 on the fourth side D is sealed off with respect to the cathode compartment. At least one, or all, of the media apertures B1 to B3 on the second side B and C1 to C3 on the third side C are sealed off with respect to the cathode compartment by the cathode compartment sealing unit.

Overall, as can be seen from FIGS. 1a to 1f, the symmetrical design of the flow field and of the media apertures A1-D3 thus enables the media apertures A1-D3 to be configured in accordance with a predefined inlet and outlet configuration, as shown by way of example in FIG. 1B, wherein, by selecting the suitable sealing units 5, 6 in the respectively appropriate orientation, in each case the inlets “H₂O In” provided for H₂O and the outlets “H₂O O₂ Out” provided for H₂O and oxygen are fluidically coupled only to the anode compartment, and the outlets “H₂ Out” provided for hydrogen are fluidically coupled only to the cathode compartment, e.g. the inlets or outlets that are not required in each case are sealed off with respect to the accordingly undesired anode or cathode compartment.

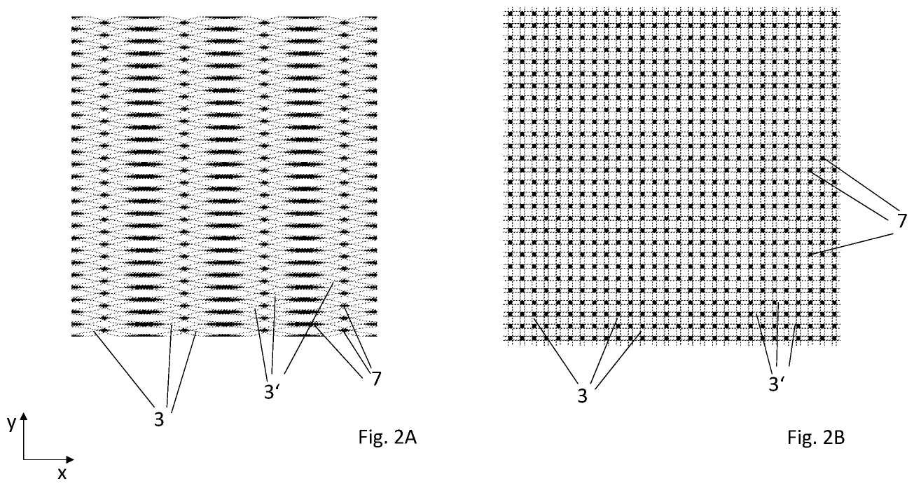

FIG. 2a shows a projection of channels 3, which according to the prior art extend in a main extension plane of a bipolar plate that can also be referred to as a plate plane, and of the channels 3′ of the next-adjacent bipolar plate onto a common projection plane. Areas in which the channels 3 overlap with the channels 3′ of the next-adjacent bipolar plate are marked as darkened contact areas 7. The distribution of the contact areas 7 is very inhomogeneous.

In comparison to this, FIG. 2B shows, in a manner analogous to FIG. 2A, the projection of the channels 3, 3′ of next-adjacent bipolar plates 1 corresponding to the solution outlined here. Again, the contact areas 7 are shown in darkened form. The contact areas 7 are in this case not only each of equal size, but are also distributed homogeneously, which both improves current collection and also brings about a more homogeneous force transmission between the adjacent bipolar plates 1, 1′, which leads to greater mechanical stability and an improved service life.

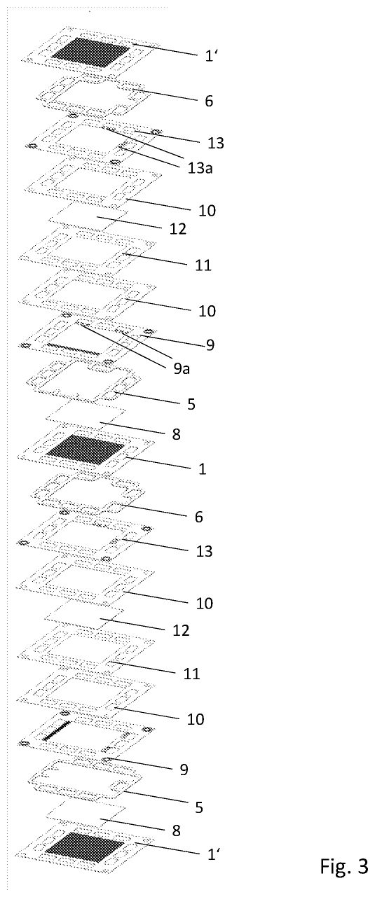

FIG. 3 shows an exemplary portion of an exploded view of an electrochemical system comprising a plurality of bipolar plates 1, l′ stacked one above the other in the stacking direction z. Between two next-adjacent bipolar plates 1, 1′, a series of further units are arranged between one bipolar plate 1 and the next-adjacent bipolar plate 1′, which is rotated in comparison to the bipolar plate 1 and the channels 3′ of which, which are rectilinear here, extend transversely to the likewise rectilinear channels 3 of the first bipolar plate 1.

For instance, in the example shown, starting from the anode side of the bipolar plate 1 and proceeding in the positive stacking direction z, first a sintered metal unit 8 is arranged, followed by the anode compartment sealing unit 5 in the appropriate orientation. Arranged after the anode compartment sealing unit 5 here is a cell frame unit 9 which has support nubs 9a projecting in the direction of the anode compartment sealing unit 5, said support nubs aiding the sealing function of other sealing units. This is achieved in that a force can be transmitted by the support studs 9a in the z-direction through the cutouts present in the anode compartment sealing unit 5. A general sealing unit 10 seals off all the inlets and outlets in the electrochemical system with respect to the anode or cathode compartment. The general sealing unit 10 is followed by a membrane unit 11, which typically comprises a membrane coated with a catalyst. Thereafter, a carbon fleece unit 12 is arranged in the cathode compartment, followed by a further general sealing unit 10. Arranged between the further general sealing unit 10 and the cathode compartment sealing unit 6 is a cathode compartment frame unit 13, which likewise has support nubs 13a projecting out of the main extension plane of the frame unit 13, said support nubs this time projecting in the direction of the cathode compartment sealing unit 6. The cathode compartment sealing unit 6 is then followed by the next-adjacent bipolar plate 1′. Here, too, the support nubs 13a again serve for vertical force transmission in order thus to improve the sealing function of the other sealing units.

This structure continues, mutatis mutandis, such that an electrochemical system comprising a plurality of alternating bipolar plates 1, l′ arranged in different flow directions F is achieved overall.

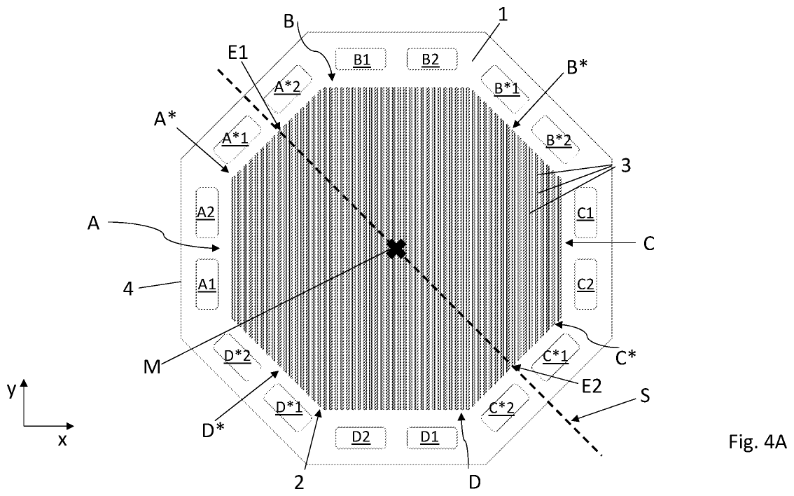

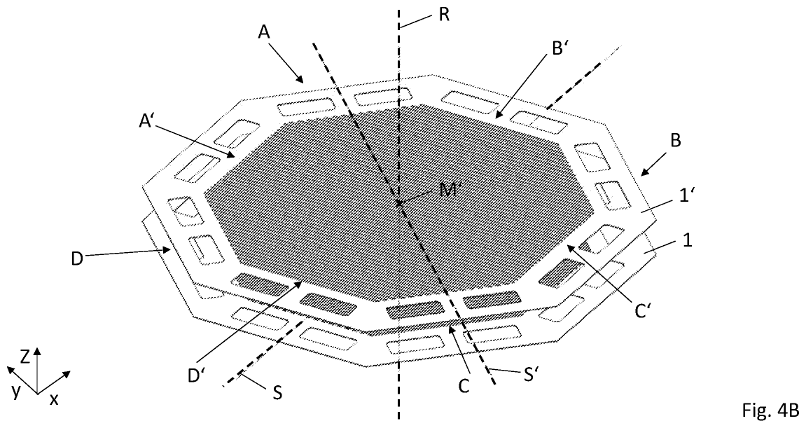

FIG. 4a shows another exemplary embodiment of a single-layer bipolar plate 1 in a plan view of the main extension plane, e.g. the xy plane of the bipolar plate 1. The bipolar plate 1 comprises a flow field 2 which is shaped substantially as an equilateral n-sided polygon, here an eight-sided polygon (equilateral octagon), said flow field being defined by a channel structure (embossed in the present case) comprising a plurality of channels 3 for a medium such as an electrolyte or water. In principle, n could also be an odd natural number. On each of four different sides A, B, C, D of the flow field 2, the bipolar plate comprises in each case at least one media aperture A1, A2, B1, B2, C1, C2, D1, D2 between the flow field 2 and a respective outer edge 4 of the bipolar plate 1. Here, in each case at least one media aperture A1, A2, B1, B2 is arranged on a first side A and on a second side B adjacent to the first side A, and in each case at least two media apertures C1, C2, D1, D2 are arranged on a third side C and on a fourth side D adjacent to the third side C. In the present case, however, a plurality of, here exactly two, media apertures A1-D2 are arranged on each of the four sides. In addition, further media apertures A*1, A*2, B*1, B*2, C*1, C*2, D*1, D*2, in the present example likewise two on each side, are arranged on further sides, namely intermediate sides A*, B*, C* and D* which are arranged between the sides A, B, C, D in a circumferential direction around a centre point M.

The media apertures A1-D2 and A*1-D*2 are arranged symmetrically with respect to an axis of symmetry S that extends from a first anchor point E1 at the edge of the flow field 2, which is located between the first side A and the second side B and is equidistant from the first and the second side A, B, to a second anchor point E2 at the edge of the flow field 2, which is located between the third side C and the fourth side D and is equidistant from the third and the fourth side C, D. In contrast to the bipolar plate of FIG. 1A, the anchor points E1, E2 are thus arranged not at respective corners of the flow field 2, but instead on the medians of the intermediate sides A*, C*.

In the example shown, the axis of symmetry S accordingly also extends through the centre point M of the flow field 2. In the present case, the media apertures A1-D2 and A*1-D*2 are also arranged point-symmetrically in relation to each other with respect to the centre point M of the flow field 2. In the example shown, the media apertures and thus also the associated scaling contours in each case have the same shape, here a substantially rectangular shape, e.g. in this example a rectangular shape with rounded corners. In the example shown, all the channels 3 are rectilinear channels 3 which extend parallel to the first side A and to the third side C located opposite the first side.

In an electrochemical system constructed using the bipolar plate 1 shown, the respective sealing units, in a manner analogous to the configurations shown in the preceding figures, may be designed to configure the media apertures A1, A2, A*1, A*2, B1, B2, B*1, B*2 and D1, D2, D*1, D*2 as “H₂O In”. Accordingly, the media apertures C1 and C*1 may then be configured as “H₂O O₂ Out” and the media apertures C2 and C*2 as “H₂ Out”.

In principle, however, the configuration options are very pronounced, which is also one of the advantages of the approach set out here. For example, even in the case of the illustrated 8-sided design of the bipolar plate 1, three media apertures may be provided on each side A, B, C, D and intermediate side A*, B*, C*, D*, as shown above on each of the four sides for the 4-sided design. In an electrochemical system comprising the scaling unit, one possibility is to configure the 3×3 media apertures on the sides A, A* and B as “H₂O In”. On the opposite sides, the sides C, C* and D, the 3×3 media apertures may then be configured for example as “H₂O O₂ Out” and “H₂ Out”, with the middle media aperture on each of these sides for example being configured as “H₂ Out” and the two other media apertures on each of these sides accordingly being configured as “H₂O O₂ Out”.

FIG. 4b shows two structurally identical bipolar plates 1, 1′, which are arranged one above the other and which are rotated through 45° (=360/n, where n=8) about the axis of rotation R. For reasons of clarity, further units that might be arranged between the two bipolar plates 1, 1′ in a ready-to-use electrochemical system are not shown here. Depending on the configuration of the media apertures A1-D*2 and the corresponding design of the electrochemical system, the bipolar plates 1, l′ shown here could also be arranged in a manner rotated through 90° relative to each other, instead of 45°.

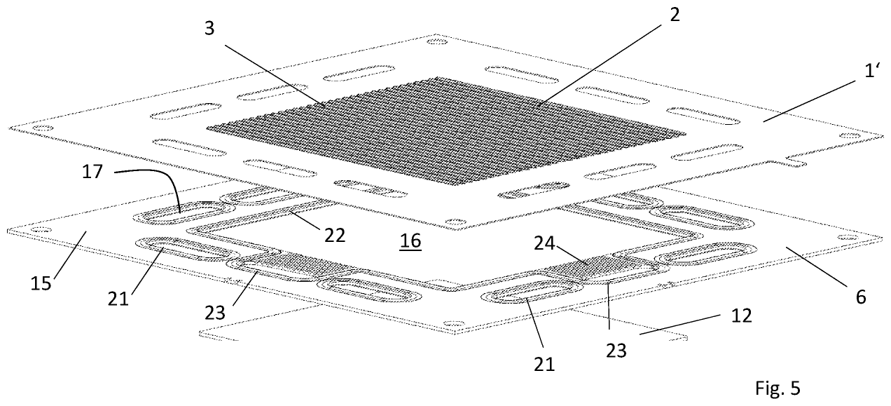

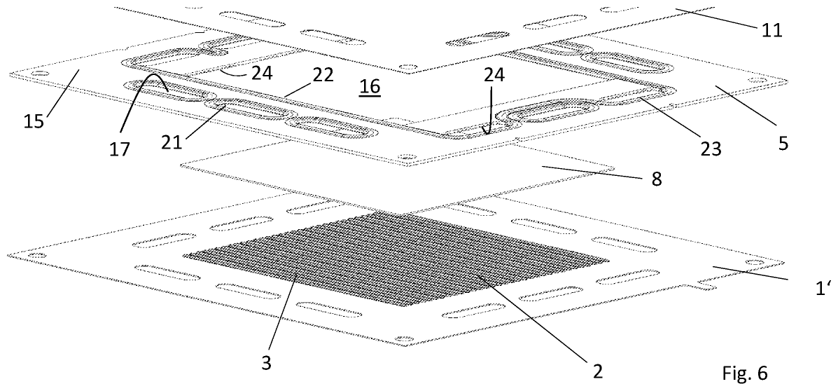

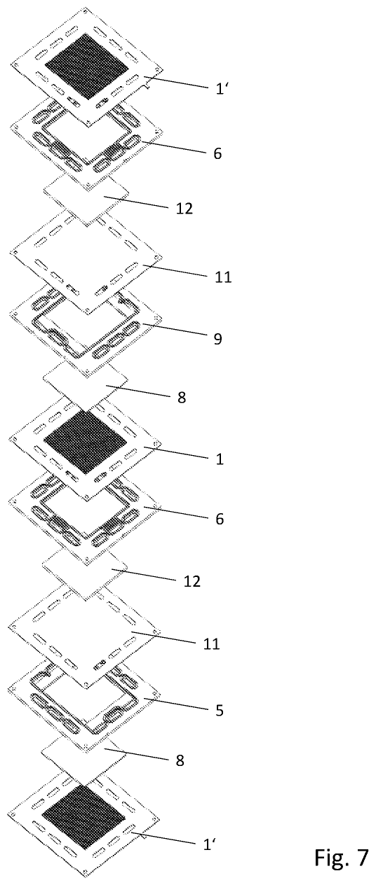

FIG. 7 shows an exploded view of two electrochemical cells of an electrolyser. FIGS. 5 and 6 show subassemblies of FIG. 7. The components shown in FIGS. 5-7 are therefore the same.

Compared to FIG. 3, the assembly of FIG. 7 comprises far fewer components, since various components are combined to form single components. For instance, the separate elements 5, 9, 10 of FIG. 3 are combined to form a single anode compartment sealing unit 5 in the embodiment of FIG. 7, while the elements 10, 13 and 6 of FIG. 3 are combined to form a single cathode compartment sealing unit 6 in the embodiment of FIG. 7.

Hereinbelow, reference is made to the scaling units of FIGS. 5-7. The sealing unit 5, 6 may comprise a frame-like layer 15 having a cutout 16, wherein the layer 15 surrounds the flow field 2 of the bipolar plate 1, 1′ in the manner of a frame, with the cutout 16 extending across this region 2. The flow field 2 of the bipolar plate 1, 1′ and the cutout 16 of the layer 15 are arranged one above the other in a congruent manner. The layer 15 may for example be designed as a metal layer, wherein the layer 15 may be provided with an electrically insulating coating. Alternatively, the layer 15 may also be made of plastic, which may be electrically insulating. The layer 15 may also have at least four through-openings 17 for the passage of media, wherein the number of through-openings 17 of the sealing unit 5, 6 corresponds to the number of media apertures A1-A3, B1-B3, C1-C3, D1-D3 of the bipolar plate 1, 1′. In the exemplary embodiment shown, there are therefore twelve through-openings 17. The twelve through-openings 17 of the layer 15 are then brought into congruence with the media apertures A1-A3, B1-B3, C1-C3, D1-D3 of the bipolar plate 1, l′.

By way of example, the scaling unit 5, 6 comprises first sealing elements 21, 23 for sealing off the through-openings 17. The sealing unit 5, 6 may also comprise a second sealing element 22 for sealing off the electrochemically active region 3 and the cutout 16. Said sealing elements 21, 22 may be designed as elastomeric sealing elements, for example elastomer beads in FIGS. 5-7, or alternatively as sealing beads. Some of the first sealing elements 21 extend circumferentially around the through-openings 17 and thus completely seal off the through-openings, so that the medium in question cannot escape laterally from the through-opening 17 or the media aperture of the bipolar plate 1, l′ located therebelow or thereabove. Some of the scaling elements 23 in turn enable a lateral flow of medium from the through-opening 17 towards the electrochemically active region or the flow field 2 of the bipolar plate 1, l′. To this end, a fluid-guiding structure 24 may be provided in conjunction with the sealing element 23 in question and may be arranged at the through-opening 17, said fluid-guiding structure extending between the through-opening 17 and the flow field 2 (e.g. the electrochemically active region) and fluidically connecting the two together.

Provided that they do not contradict each other, features of the sealing units 5, 6 that are described above in connection with FIGS. 1A-4B can be combined with the sealing units 5, 6 of FIGS. 5-7, and vice versa.

The scaling unit 5, 6 and the bipolar plate 1, l′ are thus pressed together in the electrolyser in such a way that the sealing elements 21, 22, 23 of the sealing unit 5, 6 seal off the media apertures of the bipolar plate 1, l′ and the flow field 2 of the bipolar plate 1, l′.

The above-described sealing units 5, 6 (cf. FIGS. 1A-7) perform scaling functions and ensure that the media apertures A1-A3, B1-B3, C1-C3, D1-D3 of the bipolar plate 1, l′ and the flow field 2 of the bipolar plate 1, l′ are sealed off. The sealing units 5, 6 may additionally perform the fluid-guiding function between the media aperture and the flow field 2; cf. FIGS. 5-7.

In all the embodiments of the present application, it may optionally be provided that the bipolar plate 1, l′ is substantially flat in the flow direction between the flow field 2 and each of the media apertures A1-A3, B1-B3, C1-C3 and/or D1-D3. By way of example, the bipolar plate 1, l′ is substantially flat in a first region adjoining the respective media aperture A1-A3, B1-B3, C1-C3 and/or D1-D3 and extending around the respective media aperture A1-A3, B1-B3, C1-C3 and/or D1-D3 and/or in a second region adjoining the flow field 2 and extending around the flow field 2. In said flat regions, the bipolar plate 1, l′ thus has no sealing elements such as scaling beads, elastomer seals and/or depressions for receiving elastomer seals. The sealing-off of the media apertures A1-A3, B1-B3, C1-C3 and/or D1-D3 and/or the flow field 2 and the guiding of fluid between the respective media aperture A1-A3, B1-B3, C1-C3 and/or D1-D3 and the flow field 2 may be performed by the sealing units 5, 6. A configuration of the media apertures of the bipolar plate is therefore also determined by the sealing unit 5, 6, see explanations above. The bipolar plates 1, l′ may for example be square (FIG. 7), octagonal (FIGS. 4A, 4B) or rectangular (FIG. 3).

FIGS. 1A-7 are shown approximately to scale. FIGS. 1A-7 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” or “substantially” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A single-layer bipolar plate for an electrolyser, comprising
a flow field which is shaped substantially as an equilateral n-sided polygon, said flow field being predefined by a channel structure which defines a plurality of channels for a medium, where n is an even natural number; and
at least four media apertures, wherein, on each of four different sides of the flow field, in each case at least one media aperture is arranged between the flow field and a respective outer edge of the bipolar plate;
wherein in each case at least one media aperture is arranged on a first side and on a second side adjacent to the first side;
wherein in each case at least two media apertures are arranged on a third side and on a fourth side adjacent to the third side;
wherein the media apertures are arranged symmetrically with respect to an axis of symmetry that extends from a first anchor point, which is located between the first and the second side and is equidistant from the first and the second side, to a second anchor point, which is located between the third and the fourth side and is equidistant from the third and the fourth side.

2. The bipolar plate according to claim 1, wherein n is equal to four or eight.

3. The bipolar plate according to claim 1, wherein an equal number of media apertures are arranged on each of the four different sides.

4. The bipolar plate according to claim 3, wherein the media apertures are arranged point-symmetrically in relation to each other.

5. The bipolar plate according to claim 1, wherein sealing contours associated with the media apertures in each case have the same shape and/or envelopes associated with the media apertures in each case have the same shape.

6. The bipolar plate according to claim 1, wherein most or all of the channels predefined by the channel structure are rectilinear channels.

7. An electrolyser comprising a plurality of bipolar plates according to claim 1, which are arranged one above the other in a stacking direction.

8. The electrolyser according to claim 7, wherein bipolar plates which are next-adjacent in the stacking direction are arranged in a manner rotated through 180 degrees about the axis of symmetry.

9. The electrolyser according to claim 7, wherein bipolar plates which are next-adjacent in the stacking direction are arranged in a manner rotated through 360/n degrees about an axis of rotation that extends perpendicular to the main extension plane of the bipolar plates.

10. The electrolyser according to claim 7, wherein most or all of the bipolar plates are structurally identical or at least have identical features.

11. The electrolyser according to claim 7, wherein arranged between two next-adjacent bipolar plates is a cathode compartment sealing unit which, on a cathode side of the respective bipolar plate:
seals off one or more media apertures on two adjacent sides with respect to a cathode compartment, through which the channels extend on the cathode side of the respective bipolar plate; and
seals off in each case at least one media aperture on two remaining adjacent sides with respect to the cathode compartment; and
fluidically couples in each case at least one media aperture on two remaining adjacent sides to the cathode compartment.

12. The electrolyser according to claim 7, wherein arranged between two next-adjacent bipolar plates is an anode compartment sealing unit which, on an anode side of the respective bipolar plate:
seals off in each case at least one media aperture on two different sides with respect to an anode compartment, through which the channels extend on the anode side of the respective bipolar plate;
fluidically couples one or more media apertures on a further side which is different than the two different sides, to the anode compartment;
fluidically couples in each case at least one media aperture on a remaining side to the anode compartment; and
seals off in each case at least one media aperture on the remaining side with respect to the anode compartment.
